(19) United States
(12) Patent Application Publication
(10) Pub. No.: US 2007/0296715 A1
(43) Pub. Date: Dec. 27, 2007

(54) Substrate treatment apparatus

(75) Inventor: Futoshi Shimai, Kanagawa (JP)

Correspondence Address: CARRIER BLACKMAN AND ASSOCIATES, 24101 NOVI ROAD, SUITE 100, NOVI, MI, 48375, US

(73) Assignee: Tokyo Ohka Kogyo Co., Ltd., Kawasaki-shi (JP)

(21) Appl. No.: 11/820,431

(22) Filed: Jun. 19, 2007

(30) Foreign Application Priority Data
Jun. 20, 2006 (JP) 2006-169569

(51) Int. Cl. G09G 5/00

(52) U.S. Cl. 345/204

(57) ABSTRACT

The object of the present invention is to provide a heat treatment apparatus which makes it possible to prevent the temperature distribution from fluctuating in the upper surface of a substrate to be treated. In the heat treatment apparatus, a lower case is lowered by a pantograph mechanism, and a space is formed between an upper case and a lower case which allows an arm of a robot to enter. In this state, a substrate to be treated mounted on the arm of the robot is inserted into the position above a hot plate. Next, a cylinder unit is activated so as to elevate a supporting pin and allow the supporting pin to receive the substrate to be treated from the arm of the robot. Next, the arm of the robot is retreated, and the supporting pin is lowered so as to mount the substrate to be treated on the hot plate. Concurrently, the lower case is elevated by activating the pantograph mechanism, and the sealing member attached to the upper surface of the lower case is brought into contact with the lower surface of the upper case, so that the upper case and the lower case are joined so as to form an airtight space inside.

### BACKGROUND OF THE INVENTION

1. Field of the Invention

The present invention relates to a substrate treatment apparatus for performing heat treatment and the like to a substrate to be treated such as a glass substrate or a semiconductor wafer.

2. Description of the Related Art

In order to form an integrated circuit on a substrate to be treated such as a glass substrate or a semiconductor wafer, a surface of the substrate is covered by a resist mask having a predetermined pattern, and various kinds of treatments such as CVD, etching, doping or the like are performed on the resist mask. Recently, finer masks have been needed according to higher integration and higher densification. For this purpose, various kinds of photosensitive resist materials for a mask have been developed, and attention has been paid to a chemical amplification type resist as a resist having excellent resolution and sensitivity.

In order to form a resist film having a predetermined pattern with the above-mentioned photosensitive resist, a coating liquid for forming a resist film is applied onto a surface of a substrate, the coating liquid is heated within a heat treatment apparatus so as to form a film, and thereafter the film is exposed to light at a predetermined pattern such that the area which has not been exposed to light is left as an insoluble portion in the case of a positive type resist film and the area which has been exposed to light is left as an insoluble portion in the case of a negative type resist film.

Patent document 1 has disclosed a heating apparatus. As shown in FIG. 4, the heating apparatus comprises a case 100, a cool plate 101 provided in a substantially central portion of the case 100 for cooling a substrate to be treated W, a hot plate 102 provided above the cool plate 101 for heating the substrate to be treated W, and an elevator pin 103 which penetrates the cool plate 101 and extends upward so that the upper end thereof supports the lower surface of the substrate to be treated W. Also, a robot 104 is provided on a side of the case 100, and an in-and-out opening 105 is formed on the side surface of the case 100 so as to deliver the substrate to be treated W between the robot 104.

Patent document 1: Japanese Patent Application publication No. H11-162804

In the above-described conventional heat treatment apparatus, it is necessary to form a space above the hot plate (cool plate) for allowing an arm of the robot 104 to enter. Therefore, the space above the hot plate (cool plate) becomes large in a state where the substrate to be treated is mounted on the hot plate (cool plate), which results in fluctuation of the temperature distribution of the substrate, and affects drying of the coating liquid.

### SUMMARY OF THE INVENTION

In order to solve the above-mentioned drawback, according to an aspect of the present invention, a substrate treatment apparatus comprises a case, the case being separated into an upper case and a lower case, a mounting table for mounting a substrate to be treated thereon within the case, and a supporting member which supports the upper case by mounting the periphery of the upper case thereon, wherein the lower case is vertically movable with respect to the upper case and the mounting table is supported within the lower case, and wherein the upper surface of the lower case is brought into contact with the lower surface of the upper case when the lower case is elevated, which allows the upper case to be lifted from the supporting member, and the lower surface of the upper case is air-tightly contacted with the upper surface of the lower case by the self-gravity of the upper case.

According to another aspect of the present invention, a substrate treatment apparatus comprises a case, the case being separated into an upper case and a lower case, a mounting table for mounting a substrate to be treated thereon within the case, and a elevator mechanism, wherein the upper case is vertically movable with respect to the lower case by the elevator mechanism, and the mounting table is supported within the lower case, and wherein the lower surface of the upper case is brought into contact with the upper surface of the lower case when the upper case is lowered, which allows the upper case to be lifted from the elevator mechanism, and the lower surface of the upper case is air-tightly contacted with the upper surface of the lower case by the self-gravity of the upper case.

A typical example of the mounting table supported within the lower case is a hot plate. A straightening vane may be attached to the upper case. Alternatively, in a case where a photosensitive resist is used as a coating liquid, a cool plate may be provided within the upper case because the sensitivity of the photosensitive resist film is improved by quenching.

According to the present invention, when the substrate is inserted or removed, the distance between the upper case and the lower case is opened so as to facilitate insertion and removal of the substrate. On the other hand, since the upper case and the lower case are tightly joined during treatment, the distance between the mounting table (hot plate) and the ceiling portion is reduced so as to prevent the temperature distribution from fluctuating.

In addition, as the size of a substrate to be treated is larger, the size of a case is also larger, which causes the case itself to be distorted by its self-gravity. However, by maintaining the airtight state as in the present invention, it is possible to prevent problems such as adjusting the case to be horizontal.

### BRIEF DESCRIPTION OF THE DRAWINGS

FIG. 1 is a sectional view showing an open state of the substrate treatment apparatus according to the present invention;

FIG. 2 is a sectional view showing a closed state of the substrate treatment apparatus according to the present invention;

FIG. 3 is a sectional view showing an open state of the substrate treatment apparatus according to another embodiment; and

FIG. 4 is a sectional view of a conventional substrate treatment apparatus.

### DETAILED DESCRIPTION OF THE PREFERRED EMBODIMENTS

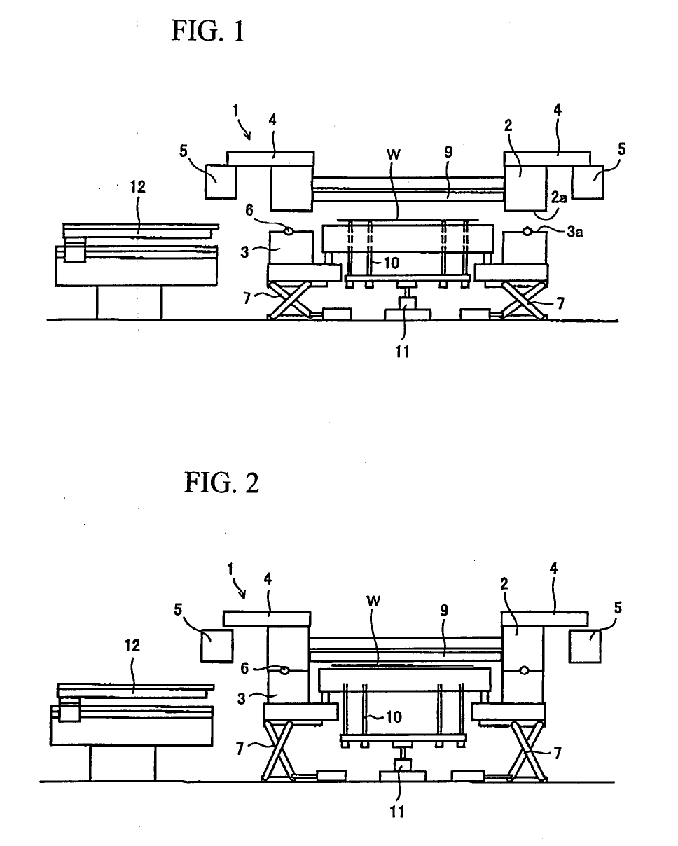

Embodiments of the present invention will now be explained hereunder with reference to the accompanying drawings. FIG. 1 is a sectional view showing an open state of the substrate treatment apparatus according to the present invention, and FIG. 2 is a sectional view showing a closed state of the substrate treatment apparatus according to the present invention. In the substrate treatment apparatus, a case 1 is separated into an upper case 2 and a lower case 3.

The upper case 2 has a flat lower surface 2a. A bracket 4 extends outward, and the bracket 4 is supported by mounting the bracket 4 on a supporting member 5. In this embodiment, the supporting member 5 is fixed without being allowed to move.

The lower case 3 has a flat upper surface 3a, and a sealing member 6 such as an O-ring is provided on the entire circumference thereof. The sealing member 6 may be attached to the lower surface 2a of the upper case 2. Also, a labyrinth packing may be used instead of the sealing member 6.

The lower case 3 is allowed to move by a pantograph mechanism 7 which is opened and closed with a horizontal cylinder unit. A hot plate 8 is provided inside the lower case 3, and a straightening vane 9 is provided inside the upper case 2 so as to be opposed to the hot plate 8. However, the straightening vane 9 is optional, and a cooling plate may be provided instead of the straightening vane 9.

A penetrating hole is formed in the thickness direction of the hot plate 8. A supporting pin 10 can be inserted into the penetrating hole, and the supporting pin 10 is movable with respect to the hot plate 8 by the cylinder unit 11 provided below the hot plate 8.

Next, operation of the substrate treatment apparatus having the above-described structure will be explained. First, as shown in FIG. 1, the lower case 3 is lowered by the pantograph mechanism 7, and a space is formed between the upper case 2 and the lower case 3 which allows an arm of a robot 12 to enter. In this state, a substrate to be treated W mounted on the arm of the robot 12 is inserted into the position above the hot plate 8. Next, the cylinder unit 11 is activated so as to elevate the supporting pin 10 and allow the supporting pin 10 to receive the substrate to be treated W from the arm of the robot 12.

Next, the arm of the robot 12 is withdrawn, and the supporting pin 10 is lowered so as to mount the substrate to be treated W on the hot plate 8. Concurrently, the lower case 3 is elevated by activating the pantograph mechanism 7, and the sealing member 6 attached to the upper surface 3a of the lower case 3 is brought into contact with the lower surface 2a of the upper case 2, so that the upper case 2 and the lower case 3 are joined so as to form an airtight space inside.

In the state where the upper case 2 and the lower case 3 are closed, the space above the substrate to be treated W is very narrow, which prevents the temperature distribution from fluctuating due to air current.

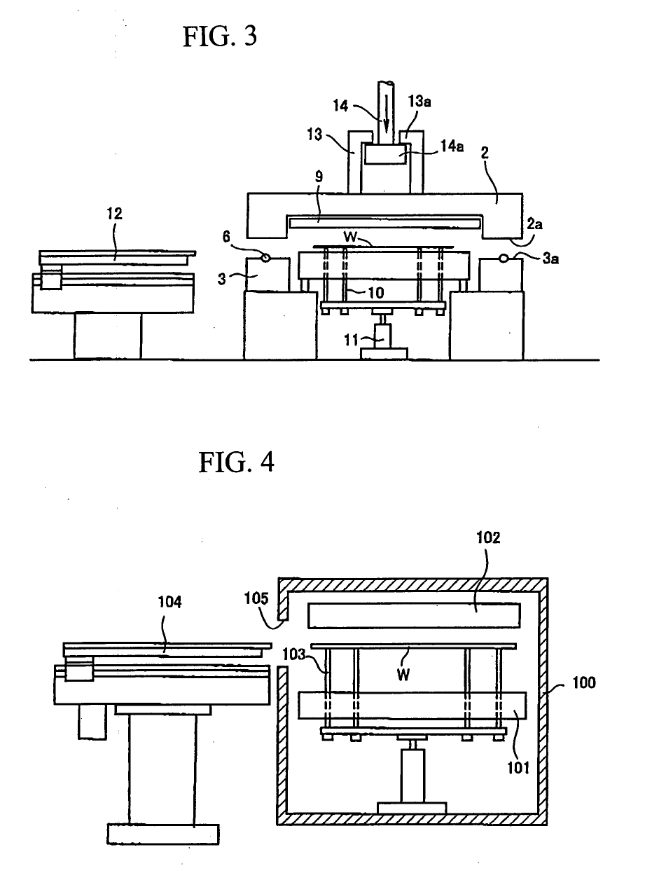

FIG. 3 is a sectional view showing an open state of the substrate treatment apparatus according to another embodiment. In this embodiment, an engaging portion 13 is provided on the upper surface of the upper case 2, and a rod 14 is inserted into the engaging portion 13. The rod 14 is vertically movable by an elevator mechanism which is not shown in the drawing. The upper surface of the engaging portion 13 forms a projecting portion 1 3a, and a large-diameter portion 14a of the rod 14 are engaged with the projecting portion 13a in a case where the rod 14 is in an elevated position, so that the upper case 2 is elevated by the rod 14.

Next, by lowering the rod 14, the lower surface 2a of the upper case 2 is brought into contact with the sealing member 6 attached to the upper surface 3a of the lower case 3, and the upper case 2 and the lower case 3 are joined so as to form an airtight space inside.

What is claimed is:

1. A substrate treatment apparatus comprising:
a case, the case being separated into an upper case and a lower case;
a mounting table for mounting a substrate to be treated thereon within the case; and
a supporting member which supports the upper case by mounting the periphery of the upper case thereon,
wherein the lower case is vertically movable with respect to the upper case and the mounting table is supported within the lower case, and wherein the upper surface of the lower case is brought into contact with the lower surface of the upper case when the lower case is elevated, which allows the upper case to be lifted from the supporting member, and the lower surface of the upper case is air-tightly contacted with the upper surface of the lower case by the self-gravity of the upper case.

2. A substrate treatment apparatus comprising:
a case, the case being separated into an upper case and a lower case;
a mounting table for mounting a substrate to be treated thereon within the case; and
a elevator mechanism,
wherein the upper case is vertically movable with respect to the lower case by the elevator mechanism, and the mounting table is supported within the lower case, and wherein the lower surface of the upper case is brought into contact with the upper surface of the lower case when the upper case is lowered, which allows the upper case to be lifted from the elevator mechanism, and the lower surface of the upper case is air-tightly contacted with the upper surface of the lower case by the self-gravity of the upper case.
